(19) United States
(12) Patent Application Publication
(10) Pub. No.: US 2017/0091329 A1
(43) Pub. Date: Mar. 30, 2017

(54) SYSTEMS AND METHODS FOR PROVIDING 3D SEARCH RESULTS

(71) Applicant: 3D PLUS LIMITED, Cheung Sha Wan (HK)

(72) Inventors: Erwin K.M. Lau, Cheung Sha Wan (HK); Wilson Cho, Cheung Sha Wan (HK); Y.k. Ma, Cheung Sha Wan (HK)

(21) Appl. No.: 15/374,236

(22) Filed: Dec. 9, 2016

Related U.S. Application Data
(63) Continuation-in-part of application No. 15/231,369, filed on Aug. 8, 2016.
(60) Provisional application No. 62/265,073, filed on Dec. 9, 2015.
(60) Provisional application No. 62/201,861, filed on Aug. 6, 2015.

(51) Int. Cl. G06F 17/30; G06F 3/0484; G06F 3/0481; G06T 19/20

(52) U.S. Cl. CPC G06F 17/30864; G06F 17/30873; G06T 19/20; G06F 3/04842; G06F 3/04815

(57) ABSTRACT

An existing two-dimensional search engine app (“2D Search App”) is transformed into a search engine that can present three-dimensional results (“3D Search App”), allowing the presentation of 3D sites and objects on a mobile device through a mobile App in communication with a central server. The client is capable of performing 3D rendering in accordance with the instructions received from the server. The client also interacts with the server to send and retrieve other data, including requests, instructions and text, images or video. The server is capable of converting 3D models into instructions which can be sent to the client, thereby allowing the client to reproduce the 3D model in the mobile device for viewing. The invention finds application in a wide range of fields, including fashion, retail outlets, and product demonstration and sales.

### CROSS-REFERENCE TO RELATED APPLICATION

The present application is a continuation-in-part of U.S. Utility Patent Application Ser. No. 15/231,369, filed Aug. 8, 2016 and entitled “METHOD OF TRANSFORMING A 2D MOBILE SEARCH APP INTO A 3D MOBILE SEARCH APP,” which claims priority to U.S. Provisional Patent Application Ser. No. 62/201,861, filed Aug. 6, 2015 and entitled “METHOD TO TRANSFORM A 2D MOBILE SEARCH APP TO A 3D MOBILE SEARCH APP” and U.S. Provisional Patent Application Ser. No. 62/265,073, filed Dec. 9, 2015 and entitled “METHOD TO TRANSFORM A 2D MOBILE SEARCH APP TO A 3D MOBILE SEARCH APP,” the entire contents of each of which are incorporated herein by reference.

### BACKGROUND

Field

The present disclosure generally relates to providing search results to a user via the Internet. More specifically, the systems and methods described herein relate to a technique that enables a search engine app on a mobile device to display true three-dimensional (3D) results, thereby allowing a user of the search engine app to navigate in a 3D site or circumnavigate a 3D object and interact with the same.

Technical Background

The mobile search market may be competitive, and search providers are constantly looking for ways to convince users to search via their applications instead of competitors' applications. In addition, the online advertising market is competitive and advertising revenue may be tied to the number of users that use a particular search engine service. Certain search engine providers, such as Google® and Baidu®, have introduced applications that are downloadable to electronic devices to ensure that such devices can access the search engines.

However, such downloadable applications only present search results in two dimensions, which may include, for example, text, images, or video. The applications do not present search results in three dimensions, particularly certain objects/search results that may be desired to be viewed in three dimensions, such as a building, a store, a 3D car model, and/or the like.

Accordingly, a need exists for a search application that can transform certain 2D search results into 3D search results and/or present search results in 3D format.

### SUMMARY

In one embodiment, a method of improving Internet-based search by providing three-dimensional (3D) search results in response to a search request includes performing, by a processing device, a registration process at a server that enables 3D results to be returned from an existing Internet website in response to a search request. The registration process includes the placement of a token at a 3D-enabled location in the Internet website indicating that 3D imagery is to be displayed when that location is accessed by a user. When the user of a mobile device accesses the Internet website, the 3D imagery is displayed on the mobile device when the user accesses the 3D-enabled location in the website.

In another embodiment, a system for improving Internet-based search by providing three-dimensional (3D) search results in response to a search request includes a processing device and a non-transitory, processor-readable storage medium. The non-transitory, processor-readable storage medium includes one or more programming instructions thereon that, when executed, cause the processing device to perform a registration process at a server that enables 3D results to be returned from an existing Internet website in response to a search request. The registration process includes the placement of a token at a 3D-enabled location in the Internet website indicating that 3D imagery is to be displayed when that location is accessed by a user. When the user of a mobile device accesses the Internet website, the 3D imagery is displayed on the mobile device when the user accesses the 3D-enabled location in the website.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts an illustrative computing network for a system for transforming search results into 3D format and/or providing 3D search results according to one or more embodiments shown and described herein;

FIG. 2 schematically depicts the server computing device from FIG. 1, further illustrating hardware and software that may be used in transforming search results into 3D and/or providing 3D search results according to one or more embodiments shown and described herein;

FIG. 3 schematically depicts the user computing device from FIG. 1, further illustrating hardware and software that may be used in providing 3D search results according to one or more embodiments shown and described herein;

FIG. 4 depicts a flow diagram of an illustrative method of enabling a 3D search result according to one or more embodiments shown and described herein;

FIG. 5 depicts a flow diagram of an illustrative method of registering a site and operating a search engine according to one or more embodiments shown and described herein.

### DETAILED DESCRIPTION

Referring generally to the figures, embodiments described herein are directed to systems and methods for transforming an existing two-dimensional search engine application installed on an electronic device (“2D search app”), into a search engine that can present three-dimensional results (“3D search app”), as well as systems and methods for the production of the three-dimensional content. The conversion process may be rapid, the 3D search app may require a minimal amount of extra storage relative to other search apps (e.g., no more than 10 MB), and the 3D search app may be released as a version upgrade.

Such systems and methods may increase the attractiveness of search results to users, as they can have a three-dimensional experience, either in viewing an object or in entering and interacting with a scene. For the same reason, it is believed that owners of conventional two-dimensional websites may also desire to convert their websites from two dimensional formats to three dimensional formats, so that when presented to the users, their websites will be more attractive to users thereof.

The systems and methods described herein, which may allow the presentation of 3D sites and objects on a mobile device, may include a client in the form of a mobile application that is in communication with a central server. The client may be capable of performing 3D rendering in accordance with the instructions received from the server. The client may also interact with the server to send and retrieve other data, including requests, instructions and text, images or video, as described in greater detail herein.

The server may be configured to convert 3D models into instructions which can be sent to the client, thereby allowing the client to reproduce the 3D model in the mobile device for viewing. These 3D models may be imported from model building applications (e.g., Autodesk® 3ds Max® or SketchUp® (Trimble, Inc, Sunnyvale, Calif.)), or by way of a proprietary template-based customization backroom.

The systems and methods described herein may be applied to a wide range of fields. As one nonlimiting example, a fashion brand which currently has an online store may wish to present its search result in a 3D store which the user can enter and view products which are available. In this case, the fashion brand may select s standard 3D option. A 3D backroom may automatically create the 3D store (size of store to be selected by the brand) and populate the store with products of the brand in synchronization with its online store. In another nonlimiting example, a restaurant may wish to present its search results in 3D, thereby highlighting its environment and settings. In this case, it may wish to modify certain standard models to display a logo, decoration, and/or images not contained in its 2D website. This may be accomplished in the customer version of a 3D backroom, as described herein. In yet another nonlimiting example, a hotel may wish to present its search results in 3D format to highlight the various facilities it has, to permit a user to view its various rooms in three dimensions, and/or the like. In this case, the hotel may need to utilize expert 3D model construction services to construct a customized 3D model for the various areas that the hotel wishes to exhibit.

The systems and methods described herein solve a problem that exists only within the realm of electronic devices and/or the Internet because the systems and methods relate specifically to displaying Internet search results on an electronic device in 3D format. That is, the systems and methods described herein improve the presentation of Internet search results, and there is no non-electronic equivalent thereof. Moreover, the method steps described herein necessarily require an electronic device and/or the Internet in order to be carried out, and thus cannot be carried out without using such an electronic device and/or the Internet. As such, the systems and methods described herein are necessarily rooted in computer technology to overcome a problem specifically arising in the realm of computer networks.

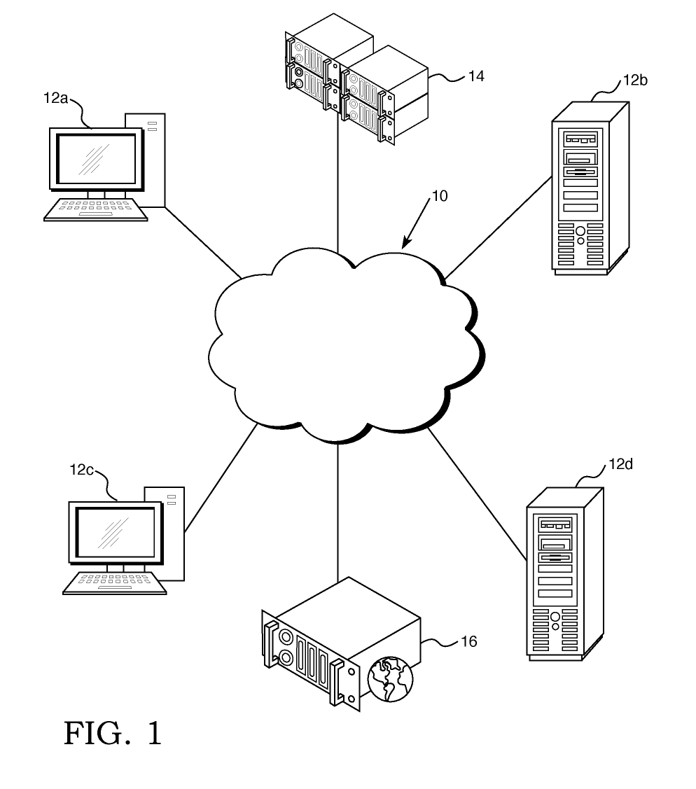

Referring now to the drawings, FIG. 1 depicts an illustrative computing network that depicts components for a system for generating and providing 3D search results. As illustrated in FIG. 1, a computer network 10 may include a wide area network (WAN), such as the Internet, a local area network (LAN), a mobile communications network, a public service telephone network (PSTN), a personal area network (PAN), a metropolitan area network (MAN), a virtual private network (VPN), and/or another network. The computer network 10 may generally be configured to electronically connect one or more computing devices and/or components thereof. Illustrative computing devices may include, but are not limited to, a user computing device 12a, a 3D rendering server computing device 12b, and an administrator computing device 12c, a search engine server computing device 12d, an application server computing device 14, and a website server computing device 16.

The user computing device 12a may generally be used as an interface between a user and the other components connected to the computer network 10. Thus, the user computing device 12a may be used to perform one or more user-facing functions, such as receiving one or more inputs from a user or providing information to the user, as described in greater detail herein. In addition, the user computing device 12a may receive information from other devices, particularly the 3D rendering server computing device, and transform the received information into a format for presenting to the user. Accordingly, the user computing device 12a may include at least a display and/or input hardware, as described in greater detail herein. In some embodiments, the user computing device 12a may be used by a user that is searching the Internet, a user using an application installed on the user computing device 12a, a user that desires to see 3D format images, and/or the like. In a particular embodiment, the user computing device 12a may be a mobile device, such as a smartphone, a tablet computing device, a phone-tablet hybrid device (“phablet”), and/or the like.

Additionally, included in FIG. 1 is the administrator computing device 12c. In the event that the 3D rendering server computing device 12b requires oversight, updating, or correction, the administrator computing device 12c may provide the desired oversight, updating, and/or correction. The administrator computing device 12c may also be used to input additional data into any corpus of data stored on the 3D rendering server computing device 12b, the application server computing device 14, the website server computing device 16, and/or the like, as described in greater detail herein.

The 3D rendering server computing device 12b may receive data from one or more sources, generate 3D rendering instructions, and/or provide information to the user computing device 12a for the purposes of generating 3D search results on the user computing device 12a. In some embodiments, the 3D rendering server computing device 12b may send instructions in real time to construct or erect the various 3D objects or 3D sites. In some embodiments, the 3D rendering server computing device 12b may transmit rules for further interactions and may receive requests or reports from the user computing device 12a. In some embodiments, the 3D rendering server computing device 12b may include a backroom application. as described in greater detail herein. In some embodiments, the 3D rendering server computing device 12b may include an application programming interface (API) that connects the backroom application with various applications of other devices, such as a backroom application located on the user computing device 12a, as described in greater detail herein.

The search engine server computing device 12d may receive data from one or more sources, generate data, index data, search data, transmit data as a result of a search, and/or the like. For example, in some embodiments, the search engine server computing device 12d may receive a search request from another computing device (e.g., the user computing device 12a), may search a corpus of data (e.g., conduct a search over the Internet) to obtain search results, and may transmit the search results to one or more computing devices.

The application server computing device 14 may provide application-specific data to the user computing device 12a. That is, the application that is installed on the user computing device 12a may be provided by the application server computing device 14, may run in conjunction with the application server computing device 14, may provide user-facing functions using application specific data that is obtained from the application server computing device 14, and/or the like. For example, in some embodiments, the application server computing device 14 may assist the user computing device 12a in processing 3D search results (e.g., transforming data into a 3D image or the like) such that they can be displayed by the user computing device 12a to a user.

The website server computing device 16 is generally a server that provides a website on the Internet. In some embodiments, the website server computing device 16 may provide a website in a three dimensional format such that the website or certain content thereon can be viewed, via the user computing device 12a, in three dimensions. In other embodiments, the website server computing device 16 may provide data to the 3D rendering server computing device 12b for the purposes of generating a 3D website (or portion thereof) for viewing on the user computing device 12a, as described in greater detail herein.

It should be understood that while the user computing device 12a and the administrator computing device 12c are depicted as personal computers and the 3D rendering server computing device 12b, the search engine server computing device 12d, the application server computing device 14, and the website server computing device 16 are depicted as servers, these are nonlimiting examples. More specifically, in some embodiments, any type of computing device (e.g., mobile computing device, personal computer, server, etc.) may be used for any of these components. Additionally, while each of these computing devices is illustrated in FIG. 1 as a single piece of hardware, this is also merely an example. More specifically, each of the user computing device 12a, the 3D rendering server computing device 12b, the administrator computing device 12c, the search engine server computing device 12d, the application server computing device 14, and the website server computing device 16 may represent a plurality of computers, servers, databases, components, and/or the like. In some embodiments, various components described with respect to FIG. 1 may be combined into a single device/system without departing from the scope of the present disclosure. For example, in some embodiments, the 3D rendering server computing device 12b and the application server computing device 14 may be combined into a single computing device that performs the functions of both the 3D rendering server computing device 12b and the application server computing device 14.

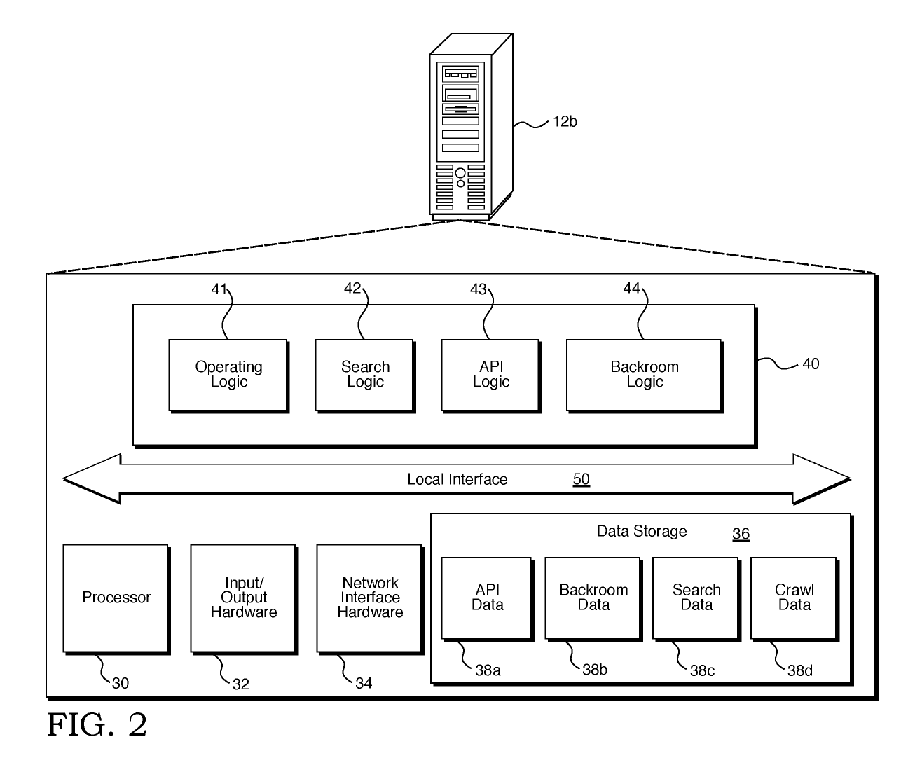

FIG. 2 depicts the 3D rendering server computing device 12b, from FIG. 1, further illustrating a system for receiving data, generating 3D rendering instructions, and/or providing information to the user computing device 12a for the purposes of generating 3D search results on the user computing device 12a, as described herein. The 3D rendering server computing device 12b may include a non-transitory computer-readable medium for searching and providing data embodied as hardware, software, and/or firmware, according to embodiments shown and described herein. The 3D rendering server computing device 12b may be configured as a generic computing device or a special purpose computer designed specifically for performing the functionality described herein.

As illustrated in FIG. 2, the 3D rendering server computing device 12b may include a processing device 30, input/output hardware 32, network interface hardware 34, a data storage component 36 (which may application programming interface (API) data 38a, backroom data 38b, search data 38c, and/or crawl data 38d), and a non-transitory memory component 40. The non-transitory memory component 40 may be configured as a volatile and/or a nonvolatile processor-readable medium and, as such, may include random access memory (including SRAM, DRAM, and/or other types of random access memory), flash memory, registers, compact discs (CD), digital versatile discs (DVD), Blu-ray discs, and/or other types of storage components. Additionally, the memory component 40 may be configured to store various processing logic, such as operating logic 41, search logic 42, API logic 43, and/or backroom logic 44 (each of which may be embodied as a computer program, firmware, or hardware, as an example). A local interface 50 is also included in FIG. 2 and may be implemented as a bus or other interface to facilitate communication among the components of the 3D rendering server computing device 12b.

The processing device 30 may include any processing component configured to receive and execute instructions (such as from the data storage component 36 and/or memory component 40). The input/output hardware 32 may include a monitor, keyboard, mouse, printer, camera, microphone, speaker, touch-screen, and/or other device for receiving, sending, and/or presenting data. The network interface hardware 34 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 36 may reside local to and/or remote from the 3D rendering server computing device 12b and may be configured to store one or more pieces of data and selectively provide access to the one or more pieces of data. As illustrated in FIG. 2, the data storage component 36 may store API data 38a, backroom data 38b, search data 38c, and/or crawl data 38d, as described in greater detail herein.

Included in the memory component 40 are the operating logic 41, the search logic 42, the API logic 43, and/or the backroom logic 44. The operating logic 41 may include an operating system and/or other software for managing components of the 3D rendering server computing device 12b. The search logic 42 may conduct one or more searches on behalf of a user (e.g., conduct a website search). It should be understood that the search logic 42 is optional, and in some embodiments may be a part of the search engine server computing device 12d (FIG. 1). The API logic 43 may contain various instructions for connecting the backroom portion of the 3D rendering server computing device 12b with a backroom of a 2D search app, a host app, or the like, thereby allowing for the exchange of information. Illustrative information exchange that may occur via the API logic may include, but is not limited to, whether a particular website contains 3D results which could be displayed on the user computing device 12a (FIG. 1), and whether a developer wishes to construct a 3D website (in which case, the backroom logic 44 of the 2D search app may redirect the developer to the 3D backroom). The backroom logic 44 may generally provide the backroom functionality, including logic for interacting with potential customers interested in placing advertising or performing various search engine optimization functions. The backroom logic 44 may further include 3D backroom functionality that receives information or instructions from users (e.g., potential customers) for the construction of 3D models or sites, such that 3D models or sites may be displayed in 3D with the appropriate information to search engine users. Due to the potential variety of needs from users, certain levels of customization may require manual assistance or participation by expert backroom operators.

It should be understood that the components illustrated in FIG. 2 are merely illustrative and are not intended to limit the scope of this disclosure. More specifically, while the components in FIG. 2 are illustrated as residing within the 3D rendering server computing device 12b, this is a nonlimiting example. In some embodiments, one or more of the components may reside external to the 3D rendering server computing device 12b. Similarly, while FIG. 2 is directed to the 3D rendering server computing device 12b, other components such as the user computing device 12a, the administrator computing device 12c, the search engine server computing device 12d, the application server computing device 14, and/or the website server computing device 16 may include similar hardware, software, and/or firmware.

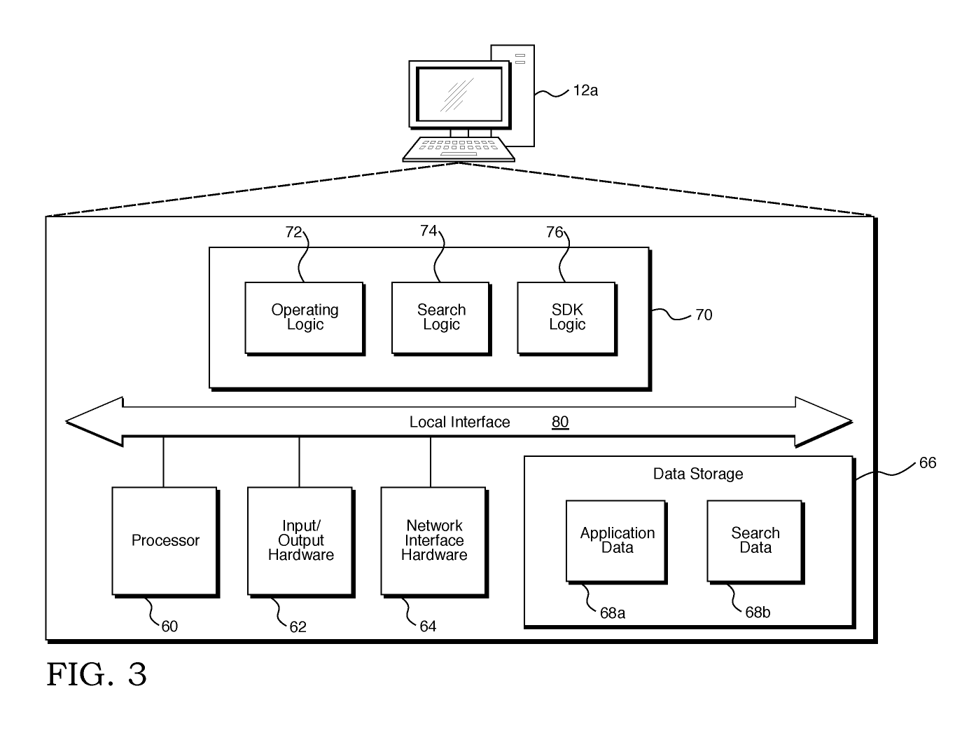

For example, illustrative hardware that may be located within the user computing device 12a is depicted in FIG. 3. The user computing device 12a may include a non-transitory computer-readable medium for interfacing with a user and providing 3D search results embodied as hardware, software, and/or firmware, according to embodiments shown and described herein. The user computing device 12a may be configured as a generic computing device or a special purpose computer designed specifically for performing the functionality described herein. In some embodiments, the user computing device 12a may be a mobile device, such as a smartphone or a tablet, as described in greater detail herein.

As illustrated in FIG. 3, the user computing device 12a may include a processing device 60, input/output hardware 62, network interface hardware 64, a data storage component 66 (which may include application data 68a and/or search data 68b), and a non-transitory memory component 70. The non-transitory memory component 70 may be configured as a volatile and/or a nonvolatile processor-readable medium and, as such, may include random access memory (including SRAM, DRAM, and/or other types of random access memory), flash memory, registers, compact discs (CD), digital versatile discs (DVD), Blu-ray discs, and/or other types of storage components. Additionally, the memory component 70 may be configured to store various processing logic, such as operating logic 72, search logic 74, and/or software developer kit (SDK) logic 76 (each of which may be embodied as a computer program, firmware, or hardware, as an example). A local interface 80 is also included in FIG. 3 and may be implemented as a bus or other interface to facilitate communication among the components of the user computing device 12a.

The processing device 60 may include any processing component configured to receive and execute instructions (such as from the data storage component 66 and/or memory component 70). The input/output hardware 62 may include a monitor, keyboard, mouse, printer, camera, microphone, speaker, touch-screen, and/or other device for receiving, sending, and/or presenting data, receiving inputs from a user of the user computing device 12a, and/or the like. The network interface hardware 64 may include any wired or wireless networking hardware, such as a modem, LAN port, wireless fidelity (Wi-Fi) card, WiMax card, mobile communications hardware, and/or other hardware for communicating with other networks and/or devices.

It should be understood that the data storage component 66 may reside local to and/or remote from the user computing device 12a and may be configured to store one or more pieces of data and selectively provide access to the one or more pieces of data. As illustrated in FIG. 3, the data storage component 66 may store application data 68a and/or search data 68b, as described in greater detail herein.

Included in the memory component 70 are the operating logic 72, the search logic 74 and/or the SDK logic 76. The operating logic 72 may include an operating system and/or other software for managing components of the user computing device 12a. The operating logic 72 may also include a particular software module in the form of a downloadable application (“app”) that acts as a client and/or provides instructions for the processing device 60 to display 3D results, either as a 3D object that is viewable from a plurality of different angles or as a 3D site in which users can navigate about freely. In both instances, a user may interact with the 3D object/3D site to obtain additional 2D or 3D information. The search logic 74 may conduct one or more searches on behalf of a user (e.g., conduct a website search) or may transmit search requests to an external device, such as, for example, the 3D rendering server computing device 12b, the search engine server computing device 12d (FIG. 1), and/or the like. The SDK logic 76 may generally provide an ability for the user computing device 12a to communicate with any 2D search app/host app, as described herein. Once the user computing device 12a is attached to a host app via the SDK logic 76, the host app can define the circumstances under which the user computing device 12a is invoked by the user, and conditions for the user to return to the host app. The 2D search app can then introduce a version upgrade with the user computing device 12a as an attachment. In order to transform a 2D search app into a 3D search app, the 2D search app may utilize the SDK logic 76 to attach the user computing device 12a to its 2D search app (which becomes the host app), modify the 2D search app to set the conditions for invoking the user computing device 12a, and publish the new hybrid app as an update version to its current 2D search app.

As previously described herein, it should be understood that the components illustrated in FIG. 3 are merely illustrative and are not intended to limit the scope of this disclosure. More specifically, while the components in FIG. 3 are illustrated as residing within the user computing device 12a, this is a nonlimiting example. In some embodiments, one or more of the components may reside external to the user computing device 12a. Similarly, while FIG. 3 is directed to the user computing device 12a, other components may include similar hardware, software, and/or firmware.

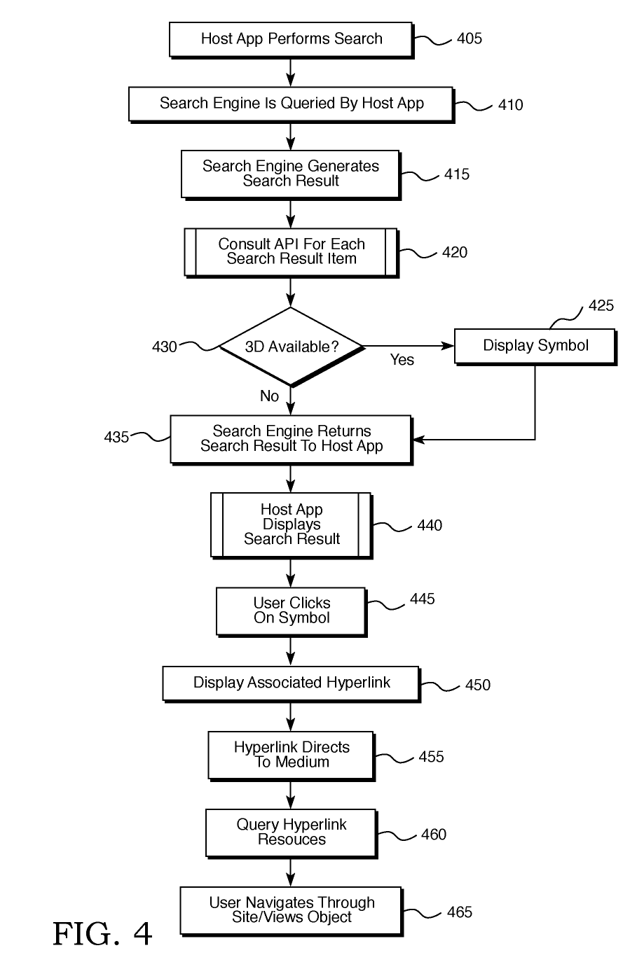

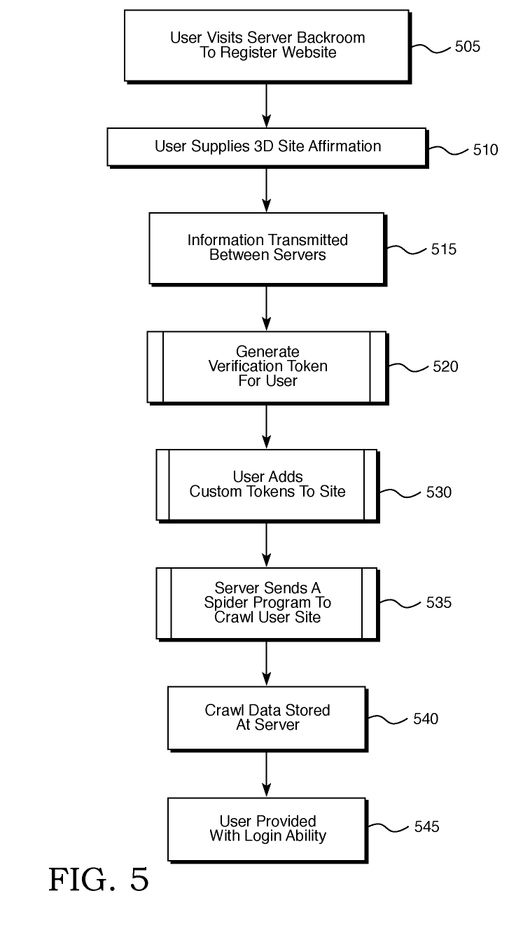

Referring now to FIGS. 4-5, the various processes described herein generally relate to methods of enabling 3D search results and methods of registering a site and operating a search engine. As a result of the methods described herein, a user has access to search results in three dimensions, which may provide a more robust navigational aspect that was previously not provided for in traditional Internet search applications.

While also referring to FIGS. 1-3, FIG. 4 depicts an illustrative production of 3D results. When a user runs a search using the user computing device 12a at step 405, the search engine server computing device 12d (FIG. 1) is queried by the user computing device 12a at step 410 to generate and return a list of search results at step 415. For each returned search result item, the API logic 43 and/or the API data 38a located on the 3D rendering server computing device 12b is consulted at step 420 to determine whether there is 3D version available at step 430. If the API logic 43 and/or the API data 38a indicate that there is an available 3D version, a 3D symbol is displayed next to the item in the list results at steps 425 and 435. If no 3D version is available the search results may displayed without a symbol at step 435. The user can then click on the 3D symbol at step 445 to access a displayed hyperlink associated with the 3D symbol at step 450. The hyperlink directs to a medium at step 455 that displays a 3D scene. The 3D scene may be a 3D object or a 3D site. The 3D scene resides, for example, on the 3D rendering server computing device 12b. Only a host app located on the user computing device 12a attached with a 3D-capable client can view the 3D scene. Upon receiving a request from the user to display the 3D scene, the hyperlink resources are queried at step 460 from the 3D rendering server computing device 12b such that the user computing device 12a can construct the 3D scene on the locations or spots according to its interpretation of the 3D rendering instructions received from the 3D rendering server computing device 12b. The constructed 3D scene can then be navigated by the user and/or the 3D object can be viewed by the user at step 465.

Still referring to FIGS. 1-3, FIG. 5 depicts an illustrative method of registering a site and operating a search engine. More specifically, FIG. 5 illustrates how 3D scenes are constructed. When a potential customer user visits a backroom on the search engine server computing device 12d to register a website at step 505, the user may select to make the website a 3D website at step 510. This intent is communicated between the various servers at step 515 (e.g., between the search engine server computing device 12d and the 3D rendering server computing device 12b).

Utilizing a website or a mobile app connected to the 3D rendering server computing device 12b (e.g., via the backroom logic 44), tokens may be generated at step 520, which can be used by the potential customer user on his/her site at step 530 to identify a particular 3D structure that is to be displayed, as well as a location or spot thereof. The 3D rendering server computing device 12b is notified by the backroom logic 44 (e.g., by obtaining the backroom data 38b), such that a web spider is sent out to crawl the potential customer user's website to discover the tokens and retrieve the information identified by the tokens at step 535. The crawled data, including the retrieved information along with the tokens which identified the locations or spots on which the information is to be displayed, will then be stored in the 3D rendering server computing device 12b as 3D rendering instructions within the crawl data 38d at step 540. The potential customer (and/or a representative thereof) is then provided with login ability at step 545 such that the potential customer can review, modify, and/or prioritize how information is best displayed on the 3D site.

Converting a 2D website into a standard 3D website containing some or all of the information in the website may include the following steps:

a) The customer utilizes a website or a mobile app, or a combination of both, which are connected to the 3D rendering server computing device 12b (e.g., using the backroom logic 44), to select the 3D structure he/she wishes to present based upon a number of different selections.

b) On each selectable structure, special locations or spots will be marked with identifications. Such locations or spots can display text, images, or video information otherwise contained in the one or more 2D websites.

c) Certain special tokens (including hypertext symbols or text) may be made available to the customer user. The customer user inserts the tokens (associated with particular spots locations or spots in the 3D structure) in the hypertext markup language used to power their 2D website(s) in accordance with instructions to indicate which information is to be displayed on which location or spots.

d) The 3D rendering server computing device 12b is notified and sends out a web spider to the website(s) (e.g., via the website server computing device 16), finds the special tokens, and retrieves the information identified by the special tokens.

e) The retrieved information, together with special tokens which identifies the locations or spots on which it is to be displayed, are then incorporated into the 3D rendering instructions to be communicated to the client to construct the 3D website containing the desired information. In the event that the information selected exceeds the permitted space within the 3D site, excess information will be made available as additional pages (which can be scrolled or turned or otherwise) viewable by a viewing user on the user computing device 12a.

f) Upon an optional review and approval of the customer, the 3D website may reside within data stored on the 3D rendering server computing device 12b.

g) The 3D rendering server computing device 12b will notify the website server computing device 16 (e.g., a host server) that the customer (identified by their 2D website or websites) has successfully produced a corresponding 3D website, so that when a search event occurs and the customer's website or websites are to be displayed, a special symbol will be inserted in the search result display to indicate that this customer has a 3D website.

h) If the search engine user taps on the special symbol using the user computing device 12a, the 3D search app will call up a client connected via the SDK, logic 76 and the user will enter into a 3D site where he will be able to navigate, view, and interact with the information presented in a real 3D experience.

i) There are default modes for the selection of structure and the placement of information so that the customer need not make all selection decisions.

j) The backroom logic 44 can be further used to streamline and simplify the token placement process for customers who utilize some of the major content management systems (such as Joomla!®), as the process will be integrated into such systems.

Converting a 2D website into a customized 3D website containing some or all of the information in the website may include the following steps:

a) In cases where the customer desires customization beyond the selection of 3D structure and placement of information, including the insertion of information other than on the 2D websites, the customer can utilize the customer version of the backroom logic 44.

b) In this version of the backroom logic, the customer can have a greater range of selection including, but not limited to, additional building styles, 2D decorations, 3D decorative objects, wall and floor textures, and styles for text.

c) If further customization is needed, including the creation of 3D sites not within the selection, the customer can utilize expert services.

Inserting custom 3D objects may include the following:

a) In some cases, the customer may wish to display custom 3D objects instead of or in addition to 3D sites, for example, an automotive brand displaying its new model car.

b) The 3D backroom logic 44 may be configured to accept standard 3D models from a number of major 3D rendering software tools and convert them into a 3D format for display.

c) In some cases, the customer can utilize expert services to construct these 3D models.

d) When constructed, the 3D models can be placed into the 3D sites, or individually called up to be displayed in the 3D search app.

e) The 3D objects can move within 3D sites, for example, a 3D car model can rotate on a pedestal to simulate a showroom, or even drive through a 3D virtual city to simulate a test drive.

3D websites with user-user interaction may include the following:

a) If, at a given time, more than one search engine user is viewing the same 3D site, then symbols (or avatars) representing these users can be made visible to other users with the placements of these symbols representing the actual location of these users as they navigate about within the 3D site, simulating a real-life encounter in a 3D environment.

b) These users can communicate with one another by tapping the symbol of the target, utilizing text, graphics (expressions), or voice.

c) If these users are registered, thereby having identifications, friends' lists or fans' lists can be created so that users can socialize further.

Typically, when a search result contains a 3D object or site, a symbol will appear on the screen of the user's mobile device. When the user taps that symbol or icon, the client will be activated on the user computing device 12a, and the user will be able to navigate or circumnavigate in the 3D site or object and interact with it. When the user is done with the 3D activities, they will be returned to the point where they first activated the 3D technology. Other possible user interface arrangements can also be utilized.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of improving Internet-based search by providing three-dimensional (3D) search results in response to a search request, the method comprising:
performing, by a processing device, a registration process at a server that enables 3D results to be returned from an existing Internet website in response to a search request, wherein:
the registration process comprises the placement of a token at a 3D-enabled location in the Internet website indicating that 3D imagery is to be displayed when that location is accessed by a user, and
when the user of a mobile device accesses the Internet website, the 3D imagery is displayed on the mobile device when the user accesses the 3D-enabled location in the website.

2. The method of claim 1, wherein the server sends out a web spider to crawl the Internet website to find the token and retrieve information identified by the token.

3. The method of claim 1, wherein the server converts a 3D model of the 3D imagery into instructions and sends the instructions to the user enabling the 3D imagery to be displayed on the mobile device.

4. The method of claim 1, wherein the 3D imagery includes a 3D object which a user may choose to view at different angles on a display of the mobile device.

5. The method of claim 1, wherein the 3D imagery includes a 3D space which a user may choose to explore on a display of the mobile device.

6. The method of claim 1, wherein the 3D imagery enables the user to select additional 2D information or additional 3D information.

7. The method of claim 1, wherein the server presents a user with a plurality of selections associated with the 3D imagery that the user wishes to display.

8. The method of claim 1, wherein the 3D imagery includes selectable locations to display text, images or video information contained in the Internet website.

9. The method of claim 1, wherein if a search request returns a result that is 3D enabled, that result is marked with a symbol or icon to indicate that the website is 3D enabled.

10. The method of claim 1, further comprising enabling, by the processing device, a user to specify custom 2D or 3D decorative effects when the 3D imagery is displayed.

11. The method of claim 1, further comprising accepting, by the processing device, 3D models from an existing 3D rendering software tool to generate the 3D imagery for display.

12. The method of claim 1, further comprising displaying, by the processing device, symbols or avatars representing multiple users navigating the same 3D-enabled website.

13. The method of claim 12, wherein the multiple users communicate with one another by tapping a symbol of the target, utilizing text, graphics (expressions), or voice.

14. The method of claim 12, further comprising creating, by the processing device, identifications, friends, or fans enabling the multiple users to socialize on the website.

15. A system for improving Internet-based search by providing three-dimensional (3D) search results in response to a search request, the system comprising:
a processing device; and
a non-transitory, processor-readable storage medium, the non-transitory, processor-readable storage medium comprising one or more programming instructions thereon that, when executed, cause the processing device to:
perform a registration process at a server that enables 3D results to be returned from an existing Internet website in response to a search request, wherein:
the registration process comprises the placement of a token at a 3D-enabled location in the Internet website indicating that 3D imagery is to be displayed when that location is accessed by a user, and
when the user of a mobile device accesses the Internet website, the 3D imagery is displayed on the mobile device when the user accesses the 3D-enabled location in the website.

16. The system of claim 15, wherein the non-transitory, processor-readable storage medium further comprises one or more programming instructions that, when executed, cause the processing device to enable a user to specify custom 2D or 3D decorative effects when the 3D imagery is displayed.

17. The system of claim 15, wherein the non-transitory, processor-readable storage medium further comprises one or more programming instructions that, when executed, cause the processing device to accept 3D models from an existing 3D rendering software tool to generate the 3D imagery for display.

18. The system of claim 15, wherein the non-transitory, processor-readable storage medium further comprises one or more programming instructions that, when executed, cause the processing device to display symbols or avatars representing multiple users navigating the same 3D-enabled website.

19. The system of claim 18, wherein the multiple users communicate with one another by tapping a symbol of the target, utilizing text, graphics (expressions), or voice.

20. The system of claim 18, wherein the non-transitory, processor-readable storage medium further comprises one or more programming instructions that, when executed, cause the processing device to create identifications, friends, or fans enabling the multiple users to socialize on the website.
